(19) United States
(12) Patent Application Publication
(10) Pub. No.: US 2015/0143797 A1
(43) Pub. Date: May 28, 2015

(54) TURBOPUMP

(71) Applicant: SNECMA, Paris (FR)

(72) Inventors: Gaelle Le Bouar, Saint-Marcel (FR); Richard Petit, Rouen (FR)

(73) Assignee: SNECMA, Paris (FR)

(21) Appl. No.: 14/408,357

(22) PCT Filed: Jun. 14, 2013
(86) PCT No.: PCT/FR2013/051394

§ 371 Date: Dec. 16, 2014

(30) Foreign Application Priority Data
Jun. 25, 2012 (FR) 1255981

(51) Int. Cl. F02K 9/46

(52) U.S. Cl. CPC F02K 9/46
USPC 60/259

(57) ABSTRACT

A feed method for feeding reaction engines including off-loading a secondary flow of a first propellant downstream from a first pump but upstream from a first turbine that is driven by expansion of the first propellant and that drives at least the first pump. The off-loading is controlled in such a manner as to achieve equilibrium between power generated by the first turbine and power consumed by the first pump, thereby stopping a rise in speed of the first turbine and the first pump at a predetermined speed lower than a nominal speed.

### BACKGROUND OF THE INVENTION

The present invention relates to the field of feeding at least one combustion chamber with at least one propellant. In the description below, the terms “upstream” and “downstream” are defined relative to the normal flow direction of a propellant in a feed circuit.

In reaction engines, and more particularly in rocket engines, thrust is typically generated by the expansion in a propulsive nozzle of hot combustion gas produced by an exothermic chemical reaction within a combustion chamber. Consequently, high pressures normally exist in the combustion chamber while it is in operation. In order to be able to continue to feed the combustion chamber in spite of those high pressures, the propellants need to be introduced into the chamber at pressures that are even higher. Various means are known in the state of the art for this purpose.

First means that have been proposed comprise pressurizing tanks containing the propellants. Nevertheless, that approach puts considerable constraints on the maximum pressure that can be reached in the combustion chamber, and thus on the specific impulse of the reaction engine. Consequently, in order to reach higher specific impulses, it has become common practice to use feed pumps. Various means have been proposed for driving such pumps, and the most usual comprise driving them by means of at least one turbine. In such a turbopump, the turbine can in turn be driven in several different ways. For example, the turbine may be driven by combustion gas produced by a gas generator. Nevertheless, in so-called “expander cycle” rocket engines, the turbine is driven by one of the propellants after it has passed through a heat exchanger in which it is heated by the combustion produced in the combustion chamber. Thus, this transfer of heat can contribute simultaneously to cooling the walls of the combustion chamber and/or of the propulsive nozzle, while also driving at least one feed pump.

Typically, the propellant feed circuits are designed to reach a steady state operation in which a specific flow rate of each propellant is delivered to the combustion chamber. Consequently, a rocket engine fed by such feed circuits reaches a stable level of thrust. Nevertheless, in certain circumstances, it may be desirable to be able to select between a plurality of stable thrust levels. In particular, it is now desired for the rocket engines for the last stages of satellite launchers to have not only the function of putting the payload into orbit, but also a function of taking the last stage out of orbit. In order to perform such “deorbiting”, and in particular in order to determine accurately where the last stage will fall, it is preferable to have a thrust level that is considerably smaller than that used while putting the payload into orbit.

In the study “Design and analysis report for the RL 10-IIB breadboard low thrust engine”, FR-18046-3, prepared for NASA on Dec. 12, 1984, a method is proposed for feeding propellants to a combustion chamber suitable for obtaining a reduced-thrust mode by opening a passage that bypasses the turbine for driving the pumps for the two propellants. Nevertheless, that solution requires additional complication to the propellant feed circuits, which is detrimental in particular to their reliability.

### OBJECT AND SUMMARY OF THE INVENTION

The present invention seeks to remedy those drawbacks. In particular, the invention seeks to provide a method of feeding at least one combustion chamber with at least a first propellant, in which said first propellant is pumped by a first pump, then heated in a heat exchanger downstream from said first pump, and expanded, after said heating, in a first turbine driving the first pump, prior to being injected, downstream from said first turbine, into the at least one combustion chamber, and that makes it possible to stop a rise in the speed of said first turbine and of said first pump at a speed that is lower than a nominal speed, and to do this without giving rise to an additional complication of the propellant feed circuits.

In at least one embodiment, this object is achieved by off-loading a secondary flow of the first propellant downstream from the first pump, but upstream from the first turbine, said off-loading being controlled in such a manner as to reach equilibrium between power generated by the first turbine and power consumed by the first pump in order to stop the rise in speed. This secondary flow is pumped by the first pump together with the main flow that is injected into the at least one combustion chamber.

By means of this off-loading, by reducing the ratio between the flow rate driving the first turbine and the flow rate pumped by the first pump, it is possible to stop the rise in the speed of the first pump so as to restrict the main flow of the first propellant delivered to the combustion chamber. The thrust generated by a rocket engine having the at least one combustion chamber fed in this way can thus be stabilized at a reduced level of thrust, which may be significantly lower than a nominal level of thrust that can be reached without off-loading.

In particular, the off-loading may be performed between the first pump and the heat exchanger, particularly, but not necessarily, via a valve for purging the first propellant. Nevertheless, off-loading may also be performed between the heat exchanger and the first turbine.

Specifically, the heat exchanger may be a heat exchanger of the so-called “regenerative” type, i.e. that heats the first propellant with heat generated in said combustion chamber. Thus, the feed circuit is a circuit of the so-called “expander” type, making use of this transfer of heat to the first propellant both for cooling the walls of the combustion chamber and/or of the propulsive nozzle, and also for driving at least the first turbine. In order to have better control over the speed of the first turbine, at least a fraction of the main flow of the first propellant may bypass at least the first turbine via a first bypass passage that is fitted with a first bypass valve. In particular, the second turbine may be situated downstream from the first turbine.

In order to feed the combustion chamber with a second propellant, the feed method may further include pumping a flow of a second propellant by a second pump and injecting at least a portion of this flow of the second propellant into the at least one combustion chamber. In particular, in order to drive the second pump, the method may also include expanding at least a portion of the main flow of the first propellant in a second turbine driving the second pump. This second turbine may be situated in particular downstream from the first turbine. In order to achieve better control over the speed of the second turbine, at least a fraction of the main flow of the first propellant may bypass at least the second turbine via a second bypass passage that is fitted with a second bypass valve.

### BRIEF DESCRIPTION OF THE DRAWINGS

The invention can be well understood and its advantages appear better on reading the following detailed description of three embodiments given as non-limiting examples. The description refers to the accompanying drawings, in which:

FIG. 1 is a diagram of a rocket engine with a propellant feed system feeding the combustion chamber of the rocket engine using a method in a first embodiment of the present invention;

FIG. 2 is a diagram of a rocket engine with a propellant feed system feeding the combustion chamber of the rocket engine using a method in a second embodiment of the present invention; and

FIG. 3 is a diagram of a rocket engine with a propellant feed system feeding the combustion chamber of the rocket engine using a method in a third embodiment of the present invention.

### DETAILED DESCRIPTION OF THE INVENTION

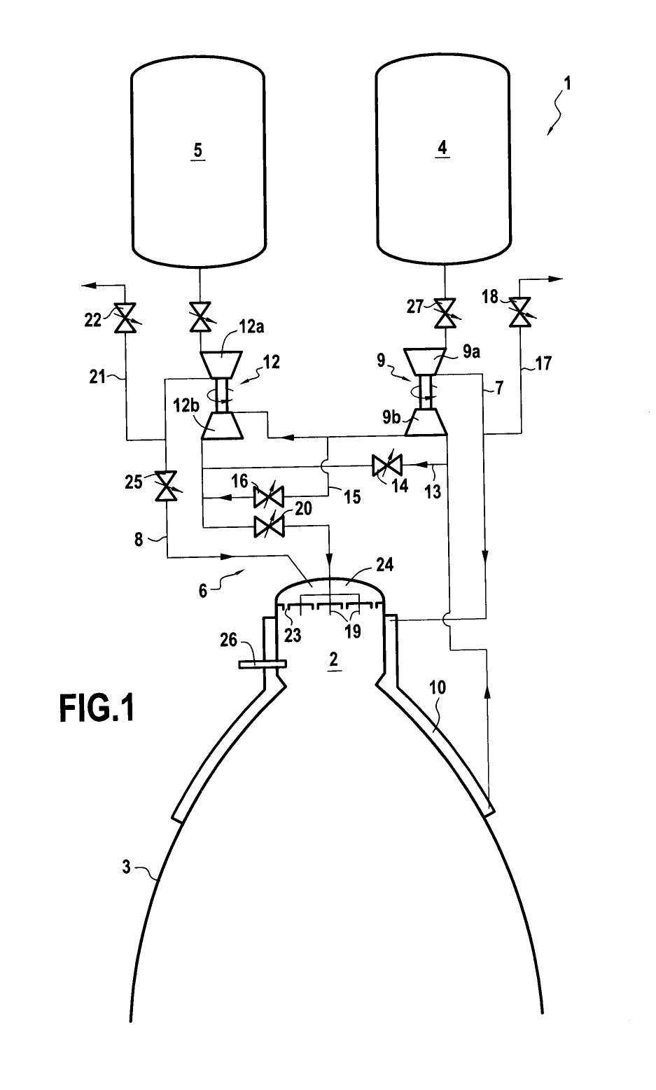

The rocket engine 1 shown in FIG. 1 comprises a combustion chamber 2 with a diverging nozzle 3, tanks 4, 5, and a feed system 6 for feeding the combustion chamber 2 with propellants coming from the tanks 4, 5. The tank 4 contains a first propellant and the tank 5 contains a second propellant. In particular, in the embodiment shown, the tanks 4, 5 may be cryogenic tanks respectively containing liquid hydrogen and liquid oxygen.

The feed system 6 comprises a first circuit 7 for the first propellant and a second circuit 8 for the second propellant. The first circuit 7 is connected to the tank 4 via a valve 27 and has a first turbopump 9 and a regenerative heat exchanger 10 incorporated in the walls of the combustion chamber 2. The first turbopump 9 comprises a first pump 9a and a first turbine 9b coupled to the first pump 9a in order to drive it. The first circuit 7 is configured in such a manner that the heat exchanger 10 is situated downstream from the first pump 9a and upstream from the first turbine 9b. A second turbine 12b is also situated downstream from the first turbine 9b in this first circuit 7. This second turbine 12b is coupled to a second pump 12a in order to drive it, said second pump 12a being situated in the second circuit 8 for pumping the second propellant. Together, the second pump 12a and the second turbine 12b form a second turbopump 12. The first circuit 7 also has a passage 13 for bypassing the two turbines 9b and 12b, this passage having a first bypass valve 14, and a passage 15 bypassing the second turbine 12b, this passage having a second bypass valve 16. Directly downstream from the first pump 9a, the first circuit 7 also has a branch connection to a purge line 17 for the first propellant, with a first propellant purge valve 18. Directly upstream from the injectors 19 for injecting the first propellant into the combustion chamber 2, the first circuit 7 also has an admission valve 20 for admitting the first propellant into the combustion chamber 2.

The second circuit 8, connected to the tank 5 via a valve 28, also comprises, downstream from the second pump 12a, a branch connection to a second propellant purge line 21 with a second propellant purge valve 22. The second circuit 8 opens out into injectors 23 for injecting the second propellant into the combustion chamber 2 via a dome 24 surmounting the combustion chamber 2. Directly upstream from the dome 24, the second circuit 8 also includes an admission valve 25 for admitting the second propellant into the combustion chamber 2. The combustion chamber 2 also has an ignitor 26. The valves 14, 16, 18, 20, 22, 25, 27, and 28, and the ignitor 26 are all connected to a control unit (not shown) in order to govern the operation of the rocket engine 1.

In operation, before igniting the rocket engine 1, the valves 27 and 28 are opened initially to enable propellants to penetrate into the circuits 7, 8 and to cool the circuit. During this cooling period, the purge valves 18 and 22 remain open, as do the bypass valves 14 and 16. Once the circuits 7 and 8 have been cooled, the valves 20 and 25 are opened to enable the two propellants to be admitted into the combustion chamber 2. The ignitor 26 is then actuated in order to ignite the propellant mixture in the combustion chamber 2. On ignition, the heat exchanger 10 begins to heat the flow of first propellant passing therethrough. The purge and bypass valves 18, 22 and 14, 16 can then be closed progressively in order to enable the speed of the turbopumps 9 and 12 to rise. During this rise in speed, an increasing flow of the first propellant, heated in the heat exchanger 10 so as to pass from the liquid state to the gaseous state, actuates the turbines 9b and 12b prior to being injected into the combustion chamber 2 via the injectors 19. The turbines 9b and 12b, in turn, drive the pumps 9a and 12a respectively, thereby increasing the flow rates of both propellants during this rise in speed.

The rise in speed of the first turbopump 9 is governed by the equation:

$$I ω \frac{d ω}{d t} = {P}_{turbine} - {P}_{pump} \qquad ( 1 )$$

where I represents the inertia of the pump 9, ω represents its speed of rotation, P_{turbine} represents the power generated by expanding the first propellant in the first turbine 9b, and Pₚᵤₘₚ represents the power consumed by the first pump 9a for pumping the first propellant. The rise in speed comes to an end when the first pump 9 reaches equilibrium in which the power P_{turbine} generated by the first turbine 9b is equal to the power Pₚᵤₘₚ consumed by the first pump 9a.

The power Pₚᵤₘₚ consumed by the first pump 9a may be written as follows:

$${P}_{pump} = \frac{{\dot{m}}_{pump} Δ {p}_{pump}}{{ρ}_{pump} {η}_{pump}} \qquad ( 2 )$$

where \dot{m}ₚᵤₘₚ designates the total mass flow rate of the first propellant driven by the first pump 9a, Δ_{Ppump} represents the pressure difference between the inlet and the outlet of the first pump 9a, ρₚᵤₘₚ represents the density of the first propellant in the liquid state on passing through the first pump 9a, and ηₚᵤₘₚ is an efficiency coefficient for the first pump.

Furthermore, by approximating the behavior of the first propellant in the gaseous state during its expansion in the first turbine 9b as being the behavior of a perfect gas, the power P_{turbine} generated by the first turbine 9b may be written as follows:

$${P}_{turbine} = {η}_{turbine} {\dot{m}}_{turbine} {c}_{P} T ( 1 - {π}^{\frac{1 - γ}{γ}} ) \qquad ( 3 )$$

where η_{turbine} is an efficiency coefficient for the first turbine 9b, \dot{m}_{turbine} is the mass flow rate of the first propellant propelling the first turbine 9b by expanding, cₚ is the specific heat capacity of the first propellant in the gaseous state at constant pressure, T is the absolute temperature of the first propellant at the inlet to the first turbine 9b, π is the ratio between the inlet pressure and the outlet pressure of the first turbine 9b, and γ is the ratio between cₚ and the specific heat capacity of the same gas at constant volume.

By combining equations (2) and (3), it is possible to deduce that the power Pₚᵤₘₚ consumed by the first turbine 9a can be greater than the power P_{turbine} generated by the first turbine 9b, thus enabling the speed of the turbopump 9 to rise, but only when the following condition is satisfied:

$$\frac{{\dot{m}}_{turbine}}{{\dot{m}}_{pump}} > \frac{Δ {p}_{pump}}{{ρ}_{pump} {η}_{pump} {c}_{P} T ( 1 - {π}^{\frac{1 - γ}{γ}} )} \qquad ( 4 )$$

If the other parameters are maintained, it is thus possible to stop the rise in speed of the first turbopump 9 by reducing this ratio between the total mass flow rate of the first turbine 9b and the total mass flow rate of the first pump 9a, which can be done by off-loading a fraction of the total flow pump by the first pump 9a upstream from the first turbine 9b.

Indirectly, this also affects the operating equilibrium of the second turbopump 12, with the torque generated by the second turbine 12b depending on the flow rate of the first propellant passing through the second turbine 12b. By off-loading a secondary flow of the first propellant, it is thus possible to control the rocket engine 1 in order to stabilize its thrust at differing levels. By governing the flow rate bypassing the turbines 9b and 12b, the bypass valves 14 and 16 can also contribute to providing fine control over the speeds of the turbopumps 9 and 12, and thus also to providing fine control of the thrust from the rocket engine 1.

In the embodiment shown in FIG. 1, the off-loading can take place through the first propellant purge line 17 by opening the first propellant purge valve 18, thereby making it possible to omit any additional elements for controlling the rocket engine in this way.

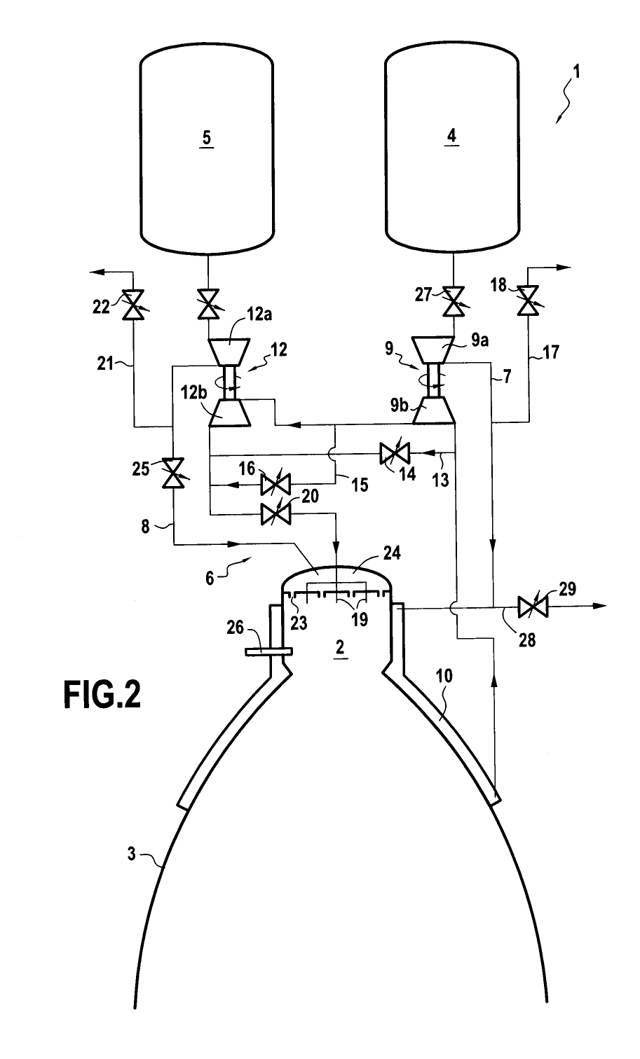

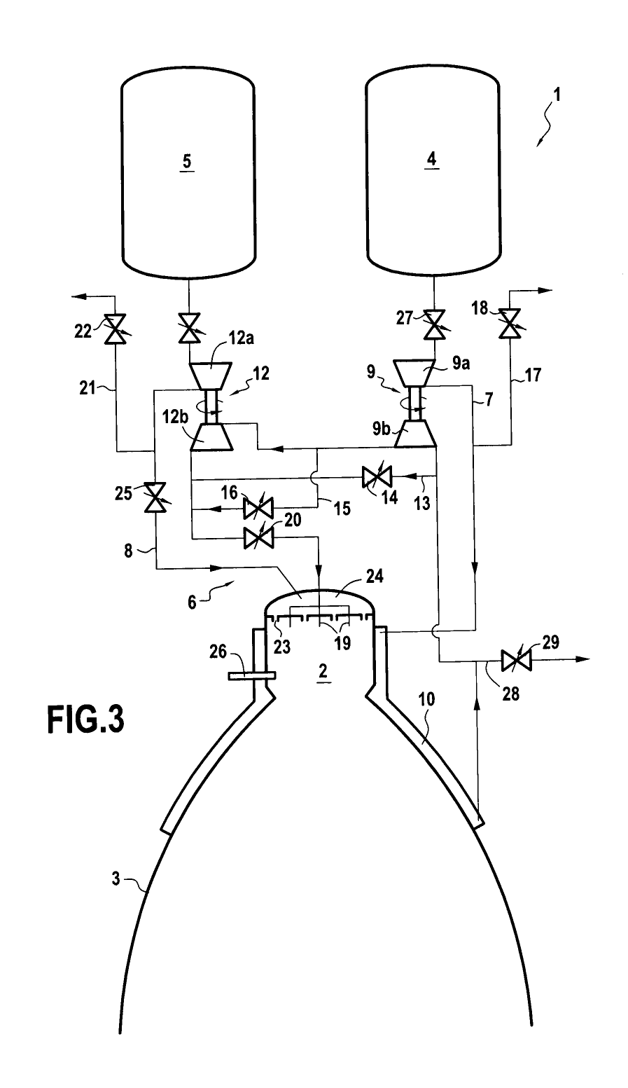

Nevertheless, in alternative embodiments, the off-loading may also take place via dedicated lines connected as branch connections to the first circuit 7 downstream from the first pump 9a, but upstream from the first turbine 9b. Thus, in the embodiments shown in FIGS. 2 and 3, in rocket engines 1 in which all the other elements are identical or equivalent to those of the embodiment shown in FIG. 1, and are consequently given the same reference numbers, the off-loading takes place via an off-loading line 28 controlled by opening an off-loading valve 29 installed in this line and connected like the other valves to the control unit (not shown) for control purposes. In the embodiment shown in FIG. 2, this off-loading line 28 is a branch connector to the first circuit 7 between the first pump 9a and the heat exchanger 10, and the secondary flow of the first propellant is thus off-loaded downstream from the first pump 9a, but upstream from the heat exchanger 10. In the embodiment shown in FIG. 3, the off-loading line 28 is situated in contrast as a branch connection to the first circuit 7 between the heat exchanger 10 and the first turbine, and the secondary flow of the first propellant is thus off-loaded downstream from the heat exchanger 10, but still upstream from the first turbine 9b. In all three situations, off-loading serves to reduce the ratio between the mass flow rate expanded in the first turbine 9b and the mass flow rate pumped by the first pump 9a, thereby stopping the rise in speed of the turbopump 9 and stabilizing the thrust from the rocket engine 1 at a desired level.

Although the present invention is described with reference to specific embodiments, it is clear that various modifications and changes can be made to those embodiments without going beyond the general scope of the invention as defined by the claims. In particular, although the pumps for the first and second propellants in all three embodiments shown are actuated by separate turbines that are connected in series in the first propellant feed circuit, it is also possible in other embodiments for them to be actuated for example by a single common turbine. In addition, individual features of the various embodiments described may be combined in additional embodiments. Consequently, the description and the drawings should be considered in a sense that is illustrative rather than restrictive.

1-10. (canceled)

11: A feed method for feeding at least one combustion chamber with at least a first propellant, the method comprising:
pumping a main flow and a secondary flow of the first propellant by a first pump;
heating at least the main flow of the first propellant in a heat exchanger downstream from the first pump;
expanding at least a portion of the main flow of the first propellant, after the heating, in a first turbine driving the first pump;
injecting the main flow of the first propellant downstream from the first turbine into the at least one combustion chamber; and
off-loading the secondary flow of the first propellant downstream from the first pump but upstream from the first turbine, the off-loading being controlled to achieve equilibrium between power generated by the first turbine and power consumed by the first pump, thereby stopping a rise in speed of the first turbine and the first pump at a predetermined speed lower than a nominal speed.

12: A feed method according to claim 11, wherein the off-loading is performed between the first pump and the heat exchanger.

13: A feed method according to claim 12, wherein the off-loading is performed via a valve for purging the first propellant.

14: A feed method according to claim 11, wherein the off-loading is performed between the heat exchanger and the first turbine.

15: A feed method according to claim 11, wherein the heat exchanger heats at least the main flow of the first propellant with heat generated in the combustion chamber.

16: A feed method according to claim 11, wherein at least a portion of the main flow of the first propellant can bypass at least the first turbine via a first bypass passage fitted with a first bypass valve.

17: A feed method according to claim 11, further comprising pumping a flow of a second propellant by a second pump and injecting at least a portion of this flow of the second propellant into the at least one combustion chamber.

18: A feed method according to claim 17, further comprising expanding at least a portion of the main flow of the first propellant in a second turbine driving the second pump.

19: A feed method according to claim 18, wherein at least a portion of the main flow of the first propellant can bypass at least the second turbine via a second bypass passage fitted with a second bypass valve.

20: A feed method according to claim 18, wherein the second turbine is situated downstream from the first turbine.
